(19) United States
(12) Patent Application Publication
(10) Pub. No.: US 2009/0138192 A1
(43) Pub. Date: May 28, 2009

(54) Navigation System

(76) Inventor: Toshio Tsuyuki, Ashigarashimo-gun (JP)

Correspondence Address: OLIFF & BERRIDGE, PLC, P.O. BOX 320850, ALEXANDRIA, VA, 22320-4850, US

(21) Appl. No.: 11/921,445

(22) PCT Filed: Jun. 7, 2006
(86) PCT No.: PCT/JP2006/311884

§ 371 Date: Dec. 20, 2007

(30) Foreign Application Priority Data
Jun. 8, 2005 (JP) 2005-195500
Jun. 22, 2005 (JP) 2005-209173
Dec. 20, 2005 (JP) 2005-381090

(51) Int. Cl. G08G 5/04

(52) U.S. Cl. 701/200

(57) ABSTRACT

[Problem] The present invention relates to a navigation system. An area where an aircraft remains for a unit time is computed as a cell using pieces of element data such as a type, a performance, a speed, and a direction of the aircraft, a trouble, and an air stream, an avoidance vector for separating overlapped cells is determined when the plural cells are overlapped with each other, and the aircraft flies manually or automatically according to the avoidance vector, whereby the navigation system prevents an accident from happening.

[Solving Means] In the navigation system, using a generating line which is of a route predicted by counting a vector defined by the speed and the direction of the aircraft in the pieces of element data such as a rotating axis, the performance, the air stream, and the trouble, a conical area is computed as the cell to manually or automatically perform the avoidance for separating the cells.

### TECHNICAL FIELD

The present invention relates to a navigation system for a movable body.

### BACKGROUND ART

Conventionally, an aircraft flies under instructions according to visual confirmations and instructions of an air traffic controller, and there is a need for understanding navigation states of the aircrafts using a system to doubly take a measure for safety.

Although it is therefore desirable that the system detect the states to systematically solve a danger, a technology cannot realize the desirable system. The same holds true in the case where the movable body is a ship and an automobile.

### DISCLOSURE OF THE INVENTION

### Problem to be Solved by the Invention

An object of the invention is to ensure safety by both the human and the system.

### Means for Solving the Problem

There is provided a navigation system including an input unit, a central processing unit, an output unit, and a storage unit, the navigation system being characterized by comprising: means for determining a vector defined by a speed and a direction of a movable body based on a program and data stored in the storage unit when the speed and the direction are input to the central processing unit from the input unit; means for determining a predicted vector including an error; and means for determining an area defined by the predicted vector as a cell, wherein the cell is determined according to a unit time.

There is provided the navigation system including the input unit, the central processing unit, the output unit, and the storage unit, being characterized in that the central processing unit includes means for computing the cell which is a conical area having the predicted vector including the error as a generating line on an assumption that the vector defined by the speed and the direction based on the program and data stored in the storage unit is used as a rotating axis when the speed and the direction of an aircraft are input to the central processing unit from the input unit.

There is provided the navigation system including the input unit, the central processing unit, the output unit, and the storage unit, being characterized in that the central processing unit includes for computing the cell which is the conical area having the predicted vector including the error as the generating line on the assumption that the vector defined by the speed and the direction based on the program and data stored in the storage unit is used as the rotating axis when the speed and the direction of the aircraft are input to the central processing unit from the input unit, and the output unit includes means for transmitting the cell of the own aircraft to another aircraft.

There is provided the navigation system including the input unit, the central processing unit, the output unit, and the storage unit, being characterized in that the central processing unit includes means for computing the cell which is the conical area having the predicted vector including the error as the generating line on the assumption that the vector defined by the speed and the direction based on the program and data stored in the storage unit is used as the rotating axis when the speed and the direction of the aircraft are input to the central processing unit from the input unit; and means for computing a cell of another aircraft based on the vector defined by the input speed and direction of another aircraft when the speed and the direction of another aircraft are input to the central processing unit of the own aircraft from the input unit.

There is provided the navigation system including the input unit, the central processing unit, the output unit, and the storage unit, being characterized in that the central processing unit includes means for computing the cell which is the conical area having the predicted vector including the error as the generating line on the assumption that the vector defined by the speed and the direction based on the program and data stored in the storage unit is used as the rotating axis when the speed and the direction of the aircraft are input to the central processing unit from the input unit, and the output unit includes means for transmitting the cell to a flight control system which controls a flight control area.

There is provided the navigation system including the input unit, the central processing unit, the output unit, and the storage unit, being characterized in that the central processing unit includes means for computing the cell which is the conical area having the predicted vector including the error as the generating line on the assumption that the vector defined by the speed and the direction based on the program and data stored in the storage unit is used as the rotating axis when the speed and the direction of the aircraft are input to the central processing unit from the input unit, and a central processing unit of the flight control system which controls the flight control area includes means for determining the cell from the vector defined by the speed and the direction of the aircraft located in the flight control area.

In the navigation system, the central processing unit is characterized by including means for computing the vectors into which the cells are separated as an avoidance vector when the cells of a plurality of aircrafts are overlapped with each other.

The navigation system is characterized in that the central processing unit of the navigation system mounted on the aircraft includes means for computing the avoidance vector.

The navigation system is characterized in that a central processing unit of the flight control system includes means for computing the avoidance vector.

The navigation system is characterized in that the output unit of the navigation system mounted on the aircraft includes means for transmitting the avoidance vector to at least either of the navigation system of another aircraft or the flight control system.

The navigation system is characterized in that an output unit of the flight control system includes mans for transmitting the avoidance vector to the input unit of the navigation system mounted on the aircraft.

The navigation system is characterized by including means for setting the vector to the speed and the direction according to the speed and the direction defined by the avoidance vector by electronic control, when the avoidance vector is computed by the navigation system mounted on the aircraft, or when the avoidance vector is input by transmission of the flight control system.

The navigation system is characterized in that a main wing and a tail plane are electronically controlled.

The navigation system is characterized in that the output unit includes means for transmitting an instruction to the input unit of the navigation system of the aircraft which should fly in the avoidance vector, the instruction adjusting and controlling the aircraft into the speed and the direction determined by the avoidance vector, and the flight control system includes means for electronically controlling the aircraft.

### Effect of the Invention

Accordingly, the navigation system of the invention can predict the route of the movable body to prevent an accident from happening during the normal and abnormal states.

### BEST MODE FOR CARRYING OUT THE INVENTION

Embodiments of the invention will be described below with reference to the accompanying drawings while taking an aircraft as an example.

Reference numeral 1 designates an input unit, 2 designates a central processing unit, 3 designates an output unit, and 4 designates a storage unit.

A navigation system according to an embodiment of the invention is mainly used in the aircraft and the like, and the navigation system is also applied to a movable body moved in a planar manner in an area or a sea area by converting three dimensions into two dimensions. The input unit 1 provides various instructions or data which are input by a key, a touch panel, or voice. The central processing unit 2 is constituted by a computer, and the central processing unit 2 includes processing means, computation and search means, and storage means.

A program and necessary data used to perform a computation and search processing are stored in the storage unit. Wired or wireless communication means can be used for input.

The processing means has a processing function realized by the program and data stored in the storage means.

The computation and search means has a function of searching data to determine the necessary data based on an instruction of the processing means.

The output unit outputs and displays sound and an image, and also outputs an instruction for controlling each mechanism of the navigation system to a control unit of each mechanism.

Each mechanism is electronically controlled to provide the necessary instruction to the control means. The position, speed, direction of the aircraft are managed, detected, and controlled.

An operation performed by the above-described configuration will be described below with reference to FIG. 2.

When the detected speed and direction are input by the input means 1 (Step 1), a cell which is a conical area having the predicted vector including the error as a generating line is computed on the assumption that the vector determined by the speed and the direction by the central processing unit 2 is used as a rotating axis (Step 2).

The vector has elements of a distance which the aircraft reaches in an arbitrarily-set unit time and a moving direction, and elements such as an air stream and a trouble with the mechanism are also used as the computation.

The generating line which is of the vector including the error draws the conical area.

The air stream and the trouble with the mechanism are also added to the set speed and direction when an avoidance vector is computed.

On the assumption that the moving vector indicating the moving state of the aircraft is used as the rotating axis, the cell which is developed in the three-dimensional conical shape is computed and output from the output unit 3.

Sometimes the conical area of the cell is deformed by dynamic elements such as the air stream.

Even if the cell different from a projected route of the aircraft is formed, it is necessary to issue a warning as an example of an abnormal state.

Pilots of both the aircrafts and the air traffic controllers are notified of the warning by the sound and image when the cells are overlapped with each other.

The overlap of the cells is clearly expressed by the sound and image, and the warning expression is returned to normal expression when the overlap of the cells is eliminated by avoiding the abnormal state.

In the case of the movement on the two-dimensional plane, the normal expression and the warning expression are performed on the two-dimensional plane by the sound and the image. The movable body in the three-dimensional space is expressed in the three-dimensional way.

In the stable flight according to the projected route, the cell can schematically be determined when the route has a curvature. When the curvature is stabilized, the area of the cell including the error is computed based on a unit of an arbitrary time, and a cylindrical cell is computed and used as a predicted cell. The cylindrical cell is obtained by disposing the predicted route in the center of a circle having the maximum area in a section perpendicular to the vector.

The predicted cylindrical cell and a tubular cell which is of the projected cell are computed. The tubular cell including an error draws a curve about the projected route. Then, the predicted cylindrical cell and the projected cell can be compared to each other to check the presence or absence of the abnormal state. Desirably the navigation system is applied to the aircraft which wheels about an air traffic control area of an airport.

When the cells of the plural aircrafts are checked by the airborne system or the flight control system to confirm the overlap of the cells (Step 3), an avoidance vector forming the not-overlapped cell is computed by the airborne system or the flight control system (Step 4), the aircraft is set to the speed flying on the avoidance vector, and the direction is also changed by manipulating a main wing or a tail plane of the aircraft. At this point, desirably the speed and the direction are automatically changed by transmitting the avoidance vector or an instruction for flying on the avoidance vector to the control unit of the electronic control apparatus without requiring human manipulation (Step 5).

In FIG. 3, reference numerals 5 and 6 designate airborne systems, and numeral 7 designates a flight control system. Transmission and reception are bi-directionally performed between the airborne systems 5 and 6 and the flight control system 7.

The image of FIG. 4 may be represented to the pilot or the air traffic controller, or the image may be input to the central processing units of the airborne systems 5 and 6 and flight control system 7 to perform the automatic control. FIG. 4 is shown only by way of example except for the example represented to the pilot and the air traffic controller. In FIG. 4, reference numerals 8, 9, and 15 designate aircrafts, 10, 11, and 16 designate cells, 12 and 13 designate avoidance vectors, and 14 designates a flight control center.

Embodiments of the invention will be described below.

A circuit element having a predetermined processing function concerning the central processing unit 2 is taken as an example in each embodiment.

The embodiments are arbitrarily selected and combined according to the applications and scenes if needed.

### First Embodiment

In the case where the position of the aircraft is obtained by, for example, satellite radio wave positioning method in the navigation system, the moving distance and direction in an arbitrarily-set unit time are computed based on the position, speed, and direction of the aircraft, and the vector can be detected in the unit time.

The actual speed and direction obtained by counting dynamic elements including the air stream and other abnormal changes as the element data into the set speed and direction of the aircraft are used as the moving vector including the error.

The vector is obtained in the form of a line segment, and the position of the aircraft is estimated in the expanded area by an influence of the randomly-changing air stream when the unit time elapses.

Therefore, the three-dimensional cell formed by the vector is formed in the conical shape having the predicted vector including the error as a generating line on an assumption that the vector is used as the rotating axis.

Because the influence of the air stream depends on the type of the aircraft, the vector is estimated in consideration of interaction among the type and speed of the aircraft, the direction of the air stream flow, the trouble with the mechanism, the dynamic element such as the abnormal change, and the set direction of the aircraft, and the cell is computed by the vector.

The central processing unit 2 performs the above-described computation.

### Second Embodiment

When the cell is computed, the cell becomes an air area which is not suitable for the flight of another aircraft. For this reason, the cell which is unsuitable unit air area at the unit time becomes extremely important information in ensuring the safety flight of both the aircrafts. The transmission means is arbitrarily selected.

Both the aircrafts should be notified of the cell as the unsuitable unit air area at the unit time, and it is necessary to transmit the cells of both the aircrafts by optical means such as a laser, electromagnetic means, or other means.

### Third Embodiment

The vector of the other aircraft can be computed from the elements such as the type, the speed, and the direction of the other aircraft and the air stream.

The central processing unit 2 included in the navigation system of the own aircraft computes the cell of the other aircraft from the information obtained by receiving the element data from the other aircraft or a third party or by receiving the element data with other identifying means such as a radar of the own aircraft.

### Fourth Embodiment

The cell obtained by the computation of the airborne navigation system is transmitted to the flight control system which controls the area where the aircraft flies.

When the change in element data approved by the flight control system or the abnormal state caused by a certain trouble is added as the new element, the cell is computed based on the new elements.

### Fifth Embodiment

The element data concerning the aircraft located in the target area to be controlled is input from the input unit 1 included in the flight control system, and the central processing unit 2 computes the cell of the aircraft based on the data.

In the case where the air traffic controller manages the flight control system, the cell is represented to the air traffic controller by the output unit 3.

In an example in which the navigation system automatically performs management, the navigation system checks whether or not the cell is the projected cell.

### Sixth Embodiment

In the case where the cells of the aircrafts are overlapped as shown in cells 10 and 11 of FIG. 4, when the pilot or the air traffic controller recognizes the overlap by the output of the navigation system to input the instruction to the navigation system, or when the navigation system detects the overlap of the cells, the central processing unit 2 of the navigation system includes means for computing the aircraft vector which can separate the overlapped cells as an avoidance vector.

### Seventh Embodiment

The central processing unit 2 of the navigation system mounted on the aircraft includes means for, when the cells of both the aircrafts are overlapped with each other, computing the avoidance vector by the input of the instruction of the pilot or the automatic operation of the navigation system.

The element of the avoidance vector includes the trouble, a variable property restricted by the speed adjustment and steering performance of the aircraft, the air stream, and the cell of the other aircraft.

### Eighth Embodiment

The central processing unit 2 of the flight control system includes means for, when the cells of the plural aircrafts are overlapped, computing the avoidance vector by the input of the instruction of the air traffic controller or the automatic operation of the flight control system.

### Ninth Embodiment

The output unit 3 of the navigation system includes means for, when the system mounted on the aircraft computes the avoidance vector, transmitting the avoidance vector to at least one of the aircraft having the overlapped cell and the flight control system.

### Tenth Embodiment

The output unit 3 includes means for, when the central processing unit 2 of the flight control system computes the avoidance vector, transmitting the avoidance vector to the input unit 1 of the navigation system mounted on the aircraft.

At this point, sometimes the avoidance vectors differ from each other because the element data input to the system mounted on the aircraft differs from the element data input to the flight control system.

It is necessary that a criterion for a degree of accuracy of the element data be set to verify apriority. However, usually the verification is made by the number of pieces of element data, the time series of the data concerning the abnormal change, or communication between the pilot and the air traffic controller.

In the emergency, the pilot makes a judgment according to an emergency avoidance manual.

### Eleventh Embodiment

When the avoidance vector is computed by the navigation system of the own aircraft, or when the avoidance vector is computed by the other aircraft or the flight control system and input to the navigation system of the own aircraft by transmission, the speed adjustment and steering are performed such that the aircraft flies according to the speed and the direction of the avoidance vector.

The avoidance vector is computed while the failure or other trouble of the own aircraft and the air stream are also set to the element.

Sometimes the speed adjustment and the steering are manually performed by the pilot according to the manual in emergency, and desirably the speed adjustment and the steering are automatically performed by the electronic control.

The navigation system includes means for integrally controlling a hydraulic mechanism using the electronic circuit, and the instruction is input to the control means from the navigation system.

Desirably the normal running state differs from the emergency state in the unit time set to compute the cell, or the unit time is changed even in the normal state.

Depending on the type of the aircraft, the cell formed by the normal flight differs from the cell formed by the element of the variable property based on the performance corresponding to the emergency. In the case where the plural cells are overlapped, it is important that the overlap of the areas forming the bottom surfaces of the conical cells determined by the positions which the aircrafts reach after the unit time elapses. Although the mode in which the plural cells intersect in a stereoscopic manner can be recognized by setting the unit time, the avoidance vector cannot be computed by the information on the overlap of the areas forming the bottom surfaces of the conical cells.

It is necessary to verify the presence or absence of the probability in which the aircrafts exist in the areas of the overlapped cells in a time zone when the cells are overlapped. It is necessary to compute the avoidance vector to take a measure except that the existence probability becomes zero.

The time zone when the relatively-high-speed aircraft exists in the overlapped area becomes short while the low-speed aircraft remains in the overlapped area for a long time. Desirably the unit time used to compute the cell coincides with the time necessary for the aircraft to reach the point at which the cells are overlapped, and it is necessary that the unit time is always changed to check the presence or absence of the overlap of the cells. The unit time is also changed by density of the aircraft located in the flight control area.

### Twelfth Embodiment

Desirably the speed adjustment and steering of the aircraft are electronically controlled by the electronic circuit included in the navigation system mounted on the aircraft. In the event of the generation of the trouble, the electronic circuit included in the flight control system secondarily complements the navigation system to transmit and input the instruction of the flight control system to the airborne system.

### Thirteenth Embodiment

When the aircraft should be broken due to a certain trouble, the speed and the direction of the aircraft are detected, and the vector is determined from the speed and the direction.

The speed and the direction of the aircraft are observed by the flight control system which controls the target air area or detection means included in the system mounted on the other aircraft, the vector of the aircraft which should be broken is determined by the detected speed and direction.

The detection means may be formed by the electromagnetic technology or the optical technology, and a method for computing a trajectory of the target aircraft tracked three-dimensionally and the like may be used as the detection means.

The determined vector is set to the rotating axis, the vector including the error of the dynamic element data such as the air stream is set to the generating line, and the conical area is computed. The conical area is set to the cell which is of the target area, and the target aircraft is broken in the cell.

The unit time used to determine the vector is arbitrarily set by the speed of the target aircraft or the breaking means.

When equipment is required to perform the breakage in the target area, a time necessary for means for transferring the equipment to the cell area and the unit time are adjusted.

When the unit time is set longer than the time necessary for transferring the equipment to the target area, it is a sufficient time to deal with the aircraft to be broken even if the target aircraft flies at high speed. The trouble of the target aircraft includes the case in which a danger occurs due to human-induced and physical causes.

Any breaking means may be used, and the breaking means including gas, a net, flight equipment, and an explosive substance is developed in the target area. A parachute, a net formed in a spherical shape, and a material having a large air resistance shape are used as the flight equipment.

### Fourteenth Embodiment

In an embodiment in which the navigation system of the invention is applied to a ship, there are static conditions such as the type and the performance, human-induced conditions such as an object and a regulation, dynamic conditions such as some sort of trouble, wind, an ocean stream, and meteorological phenomenon, and geographical conditions. Similarly to the aircraft, the system is shared by the control unit and the own ship and the other ship, and the control unit and both the ships have the functions respectively. Additionally, in the embodiment of the ship, because the conditions of the wind, ocean stream, and geography have a complex influence on the navigation system, desirably the own ship includes a system which observes and detects the conditions, the information on the conditions is provided through the communication with the other ship, or the own ship includes a system which observes, detects, or predicts the type and performance of the other ship, the object, the influence of the wind and ocean stream.

The predicted vector including the error such as the speed and the direction of the own ship, the wind, and the ocean stream is computed or the vector obtained by the maximum value of the error generated by the dynamic conditions is determined, the area defined by the vector including the error is computed as the cell according to the unit time while the vector computed by the speed and the direction of the ship is set to the center axis.

In the embodiment in which the navigation system has a positioning function with a satellite radio wave, the vector obtained by extending the trajectory is set to the center axis, and the center axis is dealt with as an approximate center axis including the influence of the wind and ocean stream. The cell can be computed by the predicted vectors obtained on the assumption that the vector is similarly influenced thereafter.

When the plural cells are overlapped, the vector including the elements of the wind and ocean stream is computed as the avoidance vector to separate the cells of the ships according to the avoidance manual.

The system used in the aircraft can also be utilized in the communication, work, and operation between the ship and the control unit which manages the control sea area.

### Fifteenth Embodiment

In an embodiment in which the navigation system is applied to the movable body such as an automobile moving at high speed on a land, when the avoidance vector is obtained, desirably the avoidance operation is manually performed by a driver except for the emergency.

Even if the target to be avoided such as a human or the other automobile exists in the cell of the own automobile, the own automobile is located in the complicated state compared with the aircraft and the ship, resulting in failing to achieve the automatic avoidance.

A factor by which the error is generated with respect to the moving vector obtained from the speed and the direction of the own moving automobile is limited to a road surface, the trouble with the mechanism, a strong wind and the like. Therefore, the area is set by the vector schematically including the error and the cell is computed.

Desirably the unit time used to compute the cell includes an element of reaction capability of the driver or the like. The element of reaction capability of the driver or the like is determined based on a standard capability, or the element of reaction capability of the driver is arbitrarily set.

When the target exists in the area of the cell obtained in the unit time, the situation or at least a warning is provided to the driver by the sound or the image.

When the operator such as the driver does not perform the avoidance operation within a predetermined time, it is necessary that the automatic avoidance operation be performed by the system. However, in principle, the avoidance operation should manually be performed by the operator.

In the automatic avoidance, only the speed reduction should be performed, and the change in direction or traffic lane should not be performed.

The navigation system of the embodiment has a function of detecting the speed and the direction of the target to be avoided. The navigation system determines whether or not the operator performs the operation within the time necessary for the avoidance, and detects whether or not the vector of the own automobile goes off out of the cell area of the target. When the vector of the own automobile does not go of f out of the cell area of the target, the warning is continuously provided.

Even if the target exists in the cell of the own automobile, sometimes the distance between the target and the own automobile is not dangerous due to the slow speed of the own automobile. Therefore, in consideration of the avoidance capability of the operator, it is necessary to set the cell according to the speed.

Desirably the unit time corresponding to the capability of the operator is used to compute the cell in each level of the speed.

Any detection method such as the acoustic sound, the radio wave, and the laser may be used to detect the target. The vector is computed from the target moving mode, the cell obtained from the target vector is determined, and it is necessary to automatically or manually perform the avoidance operation from the target cell.

Because the time necessary for the avoidance depends on both the capability of the operator and the performance of the own automobile, desirably the unit time is set such that the cell is computed by the performance of the own automobile.

In the case where an attitude of the target is hardly predicted, the cell computed by the attitude of the target is expanded, and the warning is provided when the cells of the target and own automobiles are overlapped.

### BRIEF DESCRIPTION OF THE DRAWINGS

FIG. 1 is a diagram showing a configuration of the invention.

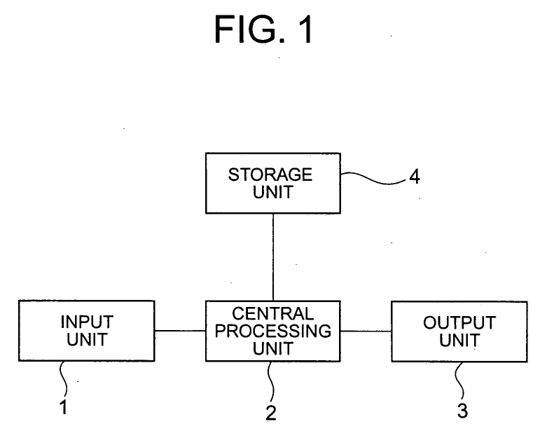

FIG. 2 is a flowchart in the invention.

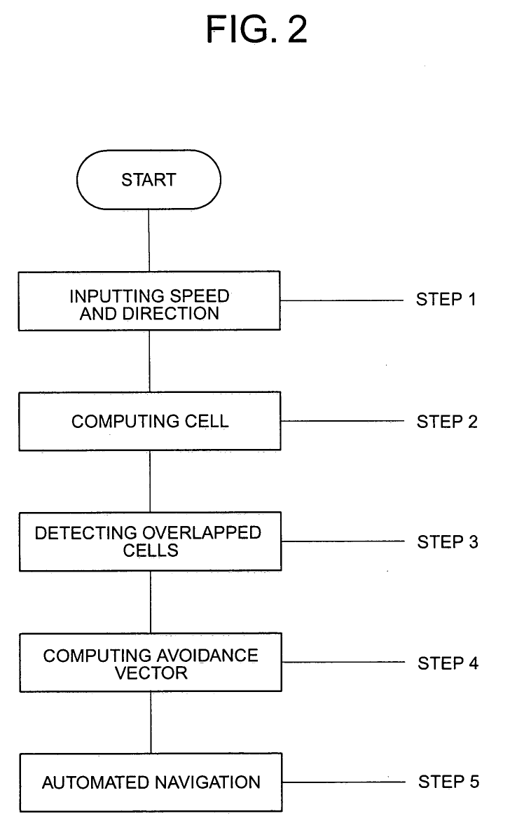

FIG. 3 is a diagram showing a system of the invention.

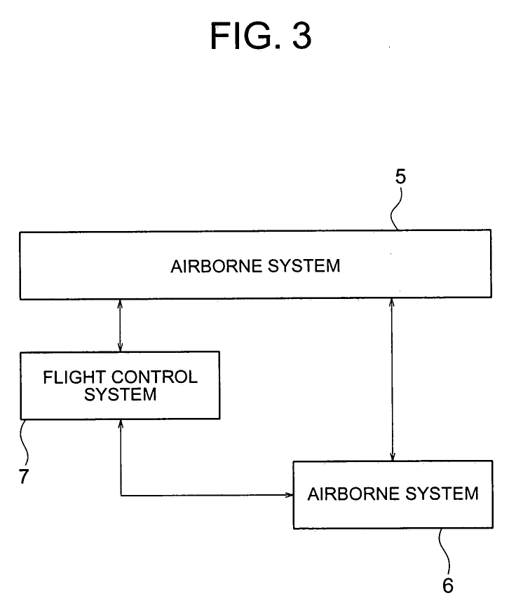

FIG. 4 is a conceptual diagram of the invention.

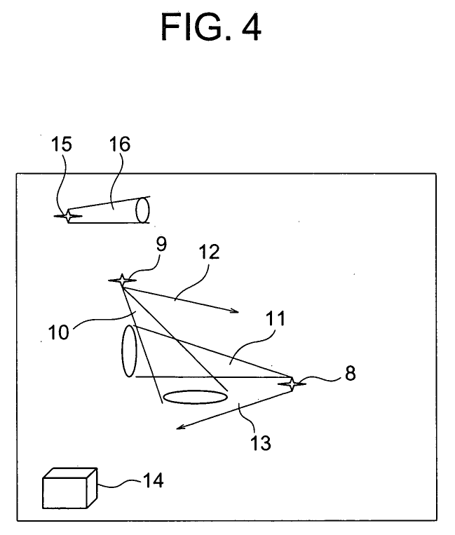

### EXPLANATION OF LETTERS OR NUMERALS

(1) input unit, (2) central processing unit, (3) output unit, (4) storage unit, (5) (6) airborne system, (7) flight control system, (8) (9) (15) aircraft, (10) (11) (16) cell, (12) (13) avoidance vector, (14) flight control center

1. A navigation system including an input unit, a central processing unit, an output unit, and a storage unit, the navigation system comprising:
means for determining a vector defined by a speed and a direction of a movable body based on a program and data stored in the storage unit when the speed and the direction are input to the central processing unit from the input unit;
means for determining a predicted vector including an error; and
means for determining an area defined by the predicted vector as a cell,
wherein the cell is determined according to a unit time.

2. The navigation system according to claim 1, wherein the central processing unit includes means for computing the cell which is a conical area having the predicted vector including the error as a generating line on an assumption that the vector defined by the speed and the direction based on the program and data stored in the storage unit is used as a rotating axis when the speed and the direction of an aircraft are input to the central processing unit from the input unit.

3. The navigation system according to claim 2, wherein
the central processing unit includes means for computing the cell which is the conical area having the predicted vector including the error as the generating line on the assumption that the vector defined by the speed and the direction based on the program and data stored in the storage unit is used as the rotating axis when the speed and the direction of the aircraft are input to the central processing unit from the input unit, and
the output unit includes means for transmitting the cell of the own aircraft to another aircraft.

4. The navigation system according to claim 2, wherein the central processing unit includes:
means for computing the cell which is the conical area having the predicted vector including the error as the generating line on the assumption that the vector defined by the speed and the direction based on the program and data stored in the storage unit is used as the rotating axis when the speed and the direction of the aircraft are input to the central processing unit from the input unit; and
means for computing a cell of another aircraft based on the vector defined by a speed and a direction of another aircraft when the speed and the direction of another aircraft are input to the central processing unit of the own aircraft from the input unit.

5. The navigation system according to claim 2, wherein the central processing unit includes means for computing the cell which is the conical area having the predicted vector including the error as the generating line on the assumption that the vector defined by the speed and the direction based on the program and data stored in the storage unit is used as the rotating axis when the speed and the direction of the aircraft are input to the central processing unit from the input unit, and
the output unit includes means for transmitting the cell to a flight control system which controls a flight control area.

6. The navigation system according to claim 2, wherein the central processing unit includes means for computing the cell which is the conical area having the predicted vector including the error as the generating line on the assumption that the vector defined by the speed and the direction based on the program and data stored in the storage unit is used as the rotating axis when the speed and the direction of the aircraft are input to the central processing unit from the input unit, and
a central processing unit of the flight control system which controls the flight control area includes means for determining the cell from the vector defined by the speed and the direction of the aircraft located in the flight control area.

7. The navigation system according to claim 2, wherein the central processing unit includes means for computing the vectors into which the cells are separated as an avoidance vector when the cells of a plurality of aircrafts are overlapped with each other.

8. The navigation system according to claim 7, wherein the central processing unit of the navigation system mounted on the aircraft includes means for computing the avoidance vector.

9. The navigation system according to claim 7, wherein the central processing unit of the flight control system includes means for computing the avoidance vector.

10. The navigation system according to claim 8, wherein the output unit of the navigation system mounted on the aircraft includes means for transmitting the avoidance vector to at least either of the navigation system of another aircraft or the flight control system.

11. The navigation system according to claim 9, wherein an output unit of the flight control system includes mans for transmitting the avoidance vector to the input unit of the navigation system mounted on the aircraft.

12. The navigation system according to claim 7, comprising: means for setting the vector to the speed and the direction according to the speed and the direction defined by the avoidance vector by electronic control, when the avoidance vector is computed by the navigation system mounted on the aircraft, or when the avoidance vector is input by transmission of the flight control system.

13. The navigation system according to claim 12, wherein a main wing and a tail plane are electronically controlled.

14. The navigation system according to claim 7, wherein the output unit includes means for transmitting an instruction to the input unit of the navigation system of the aircraft which should fly in the avoidance vector, the instruction adjusting and controlling the aircraft into the speed and the direction determined by the avoidance vector, and
the flight control system includes means for electronically controlling the aircraft.

15. The navigation system according to claim 3, wherein the central processing unit includes means for computing the vectors into which the cells are separated as an avoidance vector when the cells of a plurality of aircrafts are overlapped with each other.

16. The navigation system according to claim 4, wherein the central processing unit includes means for computing the vectors into which the cells are separated as an avoidance vector when the cells of a plurality of aircrafts are overlapped with each other.

17. The navigation system according to claim 5, wherein the central processing unit includes means for computing the vectors into which the cells are separated as an avoidance vector when the cells of a plurality of aircrafts are overlapped with each other.

18. The navigation system according to claim 6, wherein the central processing unit includes means for computing the vectors into which the cells are separated as an avoidance vector when the cells of a plurality of aircrafts are overlapped with each other.
